(19) United States
(12) Patent Application Publication
(10) Pub. No.: US 2013/0082664 A1
(43) Pub. Date: Apr. 4, 2013

(54) CHARGING METHOD AND CHARGING SYSTEM FOR LITHIUM ION SECONDARY BATTERY

(71) Applicants: Tatsuki Hiraoka, Osaka (JP); Taisuke Yamamoto, Nara (JP); Katsumi Kashiwagi, Nara (JP); Masaya Ugaji, Osaka (JP)

(72) Inventors: Tatsuki Hiraoka, Osaka (JP); Taisuke Yamamoto, Nara (JP); Katsumi Kashiwagi, Nara (JP); Masaya Ugaji, Osaka (JP)

(21) Appl. No.: 13/389,382

(22) PCT Filed: May 2, 2011
(86) PCT No.: PCT/JP2011/002534

§ 371 Date: Feb. 7, 2012

(30) Foreign Application Priority Data
Jun. 25, 2010 (JP) 2010-145064

(51) Int. Cl. H02J 7/00

(52) U.S. Cl. CPC H02J 7/0052
USPC 320/149; 320/152

(57) ABSTRACT

Charging of a lithium ion secondary battery including a positive electrode including a positive electrode active material capable of absorbing and releasing lithium ions, a negative electrode including a negative electrode active material being an alloy-formable active material capable of absorbing and releasing lithium ions, a separator interposed between the positive electrode and the negative electrode, and a non-aqueous electrolyte is performed. In charging, the remaining capacity and the temperature of the lithium ion secondary battery are detected, and the lithium ion secondary battery is charged until the battery voltage reaches a reference voltage E1 associated beforehand with the remaining capacity and the temperature.

### TECHNICAL FIELD

The present invention relates to a charging method and a charging system for a lithium ion secondary battery. More specifically, the present invention relates to control of charging of a lithium ion secondary battery having a negative electrode including an alloy-formable active material.

### BACKGROUND ART

In general, charging/discharging of a lithium ion secondary battery is controlled within the range between an end-of-charge voltage and an end-of-discharge voltage which are predetermined beforehand in association with the rated capacity. However, it has been impossible to sufficiently suppress the deterioration of the battery by such charge/discharge control which relies only on the end-of-charge and end-of-discharge voltages based on the rated capacity. For example, the following charging method is known as a technique for solving this problem.

Patent Literature 1 discloses charging a lithium ion secondary battery including a positive electrode which includes a lithium-manganese composite oxide and having a rated voltage of 4.2 V, until the battery voltage reaches a predetermined voltage within the range from 4.0 V to 4.15 V. Patent Literature 2 discloses a charging method, in which when the battery voltage of a lithium ion secondary battery drops from an end-of-charge voltage to a start-of-supplementary charge voltage due to self discharge or other reasons, supplementary charging is performed in order to raise the battery voltage from the start-of-supplementary charge voltage to the end-of-charge voltage; and the voltage is raised at a rate of 20 V/sec in the supplementary charging.

### CITATION LIST

### Patent Literature

[PTL 1] Japanese Laid-Open Patent Publication No. 2003-7349
[PTL 2] Japanese Laid-Open Patent Publication No. 2009-59665

### SUMMARY OF INVENTION

### Technical Problem

In recent years, lithium ion secondary batteries using an alloy-formable active material such as silicon or a silicon oxide as a negative electrode active material (hereinafter sometimes referred to as “alloy-type secondary batteries”) have been attracting attention. The alloy-formable active material is a material that absorbs lithium ions by being alloyed with lithium, and absorbs and releases lithium ions reversibly at a negative electrode potential. The alloy-formable active material has a large capacity, and therefore, using it can provide a lithium ion secondary battery with a higher capacity.

Studies by the present inventors have revealed that when such alloy-type secondary batteries are charged and discharged repeatedly, the particles of alloy-formable active material expand and contract repeatedly, causing cracks at the surface and in the interior of the alloy-formable active material particles, and thus creating new surfaces where no inactive coating is present (hereinafter referred to as “newly-created surfaces”). It is further revealed that a side reaction occurs between the newly-created surfaces immediately after creation and the non-aqueous electrolyte.

Due to this side reaction, the non-aqueous electrolyte is decomposed, and gas responsible for battery swelling is generated. Further, due to this side reaction, a byproduct responsible for deterioration of the alloy-formable active material particles is produced, and the alloy-formable active material particle partially absorbs and releases lithium ions, and undergoes uneven changes in volume. Moreover, the non-aqueous electrolyte is decomposed and consumed, and electrolyte depletion (lack of electrolyte) occurs, that is, the electrode and the non-aqueous electrolyte fail to be in sufficient contact with each other. If such a side reaction occurs at the negative electrode, electrolyte depletion and cracks in the active material particles also occur at the positive electrode, and as a result, the increase in swelling amount and the deterioration in cycle characteristics of the alloy-type secondary battery are accelerated.

The present invention intends to provide a charging method and a charging system for a lithium ion secondary battery, which can solve the above-mentioned problems, that is, which can suppress the deterioration that occurs in association with repeated charge and discharge of a lithium ion secondary battery.

### Solution to Problem

One aspect of the present invention is a charging method for a lithium ion secondary battery which includes a positive electrode including a positive electrode active material capable of absorbing and releasing lithium ions, a negative electrode including a negative electrode active material being an alloy-formable active material capable of absorbing and releasing lithium ions, a separator interposed between the positive electrode and the negative electrode, and a non-aqueous electrolyte.

The method includes the steps of detecting a remaining capacity and a temperature of the lithium ion secondary battery, and charging the lithium ion secondary battery until a battery voltage reaches a reference voltage E1 associated beforehand with the remaining capacity and the temperature.

The reference voltage E1 is set, for example, within the range of 90 to 99.5%, and preferably within the range of 90 to 99% of the voltage of the lithium ion secondary battery in a fully charged state, when the battery temperature detected is within the range of 40 to 60° C., and the remaining capacity detected is within the range of 80 to 95% of the rated capacity of the lithium ion secondary battery.

Another aspect of the present invention is a charging system for a lithium ion secondary battery, the system including:

a remaining capacity detecting unit for detecting a remaining capacity of the lithium ion secondary battery;

a temperature detecting unit for detecting a temperature of the lithium ion secondary battery;

a voltage measuring unit for detecting a voltage of the lithium ion secondary battery; and

a charge controller for controlling charging of the lithium ion secondary battery upon reception of input signals from the remaining capacity detecting unit, the temperature detecting unit, and the voltage measuring unit.

The charge controller charges the lithium ion secondary battery by the above charging method.

### Advantageous Effects of Invention

According to the present invention, it is possible to maintain the battery capacity and cycle characteristics of a lithium ion secondary battery using an alloy-formable active material, at a high level over a long period of time. In addition, it is possible to significantly suppress the swelling of the battery.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A flowchart for explaining each step in a charging method for a lithium ion secondary battery, according to a first embodiment of the present invention.

FIG. 2 A functional block diagram schematically showing the configuration of a charging system for a lithium ion secondary battery, according to a second embodiment of the present invention.

FIG. 3 A longitudinal cross-sectional view schematically showing the configuration of a lithium ion secondary battery included in the charging system shown in FIG. 1.

FIG. 4 A side view schematically showing the internal configuration of an electron beam vacuum vapor deposition apparatus.

### DESCRIPTION OF EMBODIMENTS

A lithium ion secondary battery using an alloy-formable active material includes a negative electrode which includes an alloy-formable active material. The capacity density of an alloy-formable active material is high as compared to that of a positive electrode active material such as a lithium composite oxide. In addition, an alloy-formable active material has a very high irreversible capacity. The irreversible capacity is defined as an amount of lithium that had been absorbed in the negative electrode during the initial charge after fabrication of the battery but has not been released from the negative electrode during the subsequent discharge. If part of the lithium contained in the positive electrode active material is absorbed in the negative electrode as an irreversible capacity during the initial charge, the amount of lithium to be involved in the charge/discharge reaction becomes small, and the battery capacity is significantly reduced. For this reason, in an alloy-type secondary battery, lithium is supplemented into the negative electrode in an amount equivalent to the irreversible capacity, prior to fabrication of the battery.

Basically, the lithium supplemented in an amount equivalent to the irreversible capacity is not assumed to be released from the negative electrode. However, the present inventors have found that part of lithium supplemented into the negative electrode beforehand is reversibly absorbed and released, although the amount of such lithium is small. In particular, when the temperature of the battery is high, the amount of lithium to be absorbed and released is increased. This means that the negative electrode in a fully charged state contains a larger amount of lithium than the theoretical amount of lithium that the positive electrode active material in the positive electrode can absorb. If lithium is released from the negative electrode in such a state during discharging, the positive electrode active material layer will absorb a larger amount of lithium than the theoretical amount, and as a result, expand excessively.

If charging is performed while the positive electrode active material layer is expanded by discharging, a large amount of lithium is deintercalated all at once from the positive electrode active material layer, and as a consequence, cracks may occur in the positive electrode active material particles, or the crystal structure thereof may be destructed. Presumably because of this, decomposition of the non-aqueous electrolyte or generation of gas occurs.

The present inventors have conducted further studies based on the foregoing findings, and found that the above-discussed problem can be solved by controlling the conditions for charging on the basis of a remaining capacity and a temperature of the battery, and arrived at the present invention.

Specifically, the charging method for a lithium ion secondary battery of the present invention relates to a charging method for a lithium ion secondary battery which includes a positive electrode including a positive electrode active material capable of absorbing and releasing lithium ions, a negative electrode including a negative electrode active material being an alloy-formable active material capable of absorbing and releasing lithium ions, a separator interposed between the positive electrode and the negative electrode, and a non-aqueous electrolyte. The method according to one embodiment of the present invention includes the steps of: detecting a remaining capacity and a temperature of the lithium ion secondary battery; and charging the lithium ion secondary battery until the battery voltage reaches a reference voltage E1 which is associated beforehand with the remaining capacity and the temperature.

According to the charging method as above, when the temperature of the battery is high and lithium supplemented in an amount equivalent to the irreversible capacity is readily released, the quantity of charged electricity can be decreased. For example, by setting the reference voltage E1 to a voltage sufficiently lower than the voltage in a fully charged state based on the rated capacity, excessive absorption of lithium in the positive electrode active material during discharging can be suppressed. On the other hand, when the temperature of the battery is low and lithium supplemented in an amount equivalent to the irreversible capacity is not readily released, the quantity of charged electricity can be increased. For example, by setting the reference voltage E1 to a voltage equal to or slightly lower than the voltage of the battery in a fully charged state based on the rated capacity, charging for ensuring a sufficient capacity can be performed. As a result, it is possible to suppress the deterioration in cycle characteristics and swelling of the battery, without causing a deterioration of the positive electrode and without reducing the battery capacity.

Here, the charging of the lithium ion secondary battery can be performed by constant-current/constant-voltage charging. In constant-current/constant-voltage charging, the lithium ion secondary battery is charged at a constant current until the battery voltage reaches a predetermined end-of-charge voltage, and the charging is continued while the battery voltage is kept at that voltage, until the current drops to a predetermined end-of-charge current, upon which the charging is terminated. In this embodiment, charging is performed at a constant current until the battery voltage reaches the reference voltage E1, and then, constant-voltage charging is performed at that voltage.

The reference voltage E1 is set in association not only with the temperature of the battery but also with the remaining capacity of the battery. For example, when the remaining capacity is within the range of 80 to 95% of the rated capacity, the reference voltage E1 is set at a higher voltage, with taking into consideration the quantity of electricity that can be additionally charged at that temperature. By setting as above, the quantity of charged electricity will not be increased excessively. In addition, for example, even when the temperature of the battery fluctuates greatly during charging and discharging, the battery can be charged at an appropriate reference voltage E1.

Here, the remaining capacity can be determined by, for example, integrating products of a discharge current value of the lithium ion secondary battery and a discharge time thereof from its fully charged state. For example, the remaining capacity can be determined by subtracting the integrated value from the rated capacity.

Alternatively, the remaining capacity can be detected by measuring the voltage of the lithium ion secondary battery.

The reference voltage E1 is set, for example, within the range of 90 to 99.5% and preferably within the range of 90 to 99% of the voltage of the lithium ion secondary battery in a fully charged state, when the detected temperature of the battery is within the range of 40 to 60° C.

When the temperature of the battery is below 40° C., the reference voltage E1 can be set at a higher voltage. When the temperature of the battery exceeds 60° C., the reference voltage E1 can be set at a lower voltage.

The charging method for a lithium ion secondary battery according to another embodiment of the present invention further includes the step of preliminarily charging the lithium ion secondary battery by constant-current charging until the battery voltage reaches a preliminary reference voltage E2 satisfying E1≧E2, before detecting the remaining capacity and the temperature of the lithium ion secondary battery. It is preferable to detect the remaining capacity and the battery temperature after the lithium ion secondary battery has been charged at a constant current until the battery voltage has reached the preliminary reference voltage E2.

It is desirable to determine the preliminary reference voltage E2, assuming that the lithium ion secondary battery in such a state that the temperature thereof had reached near the maximum operable temperature has been discharged to a fully discharged state. In other words, it is preferable to set the preliminary reference voltage E2 such that, even at the temperature close to the upper limit, the amount of lithium to be released from the negative electrode will not exceed the theoretical amount of lithium that the positive electrode active material in the positive electrode can absorb. Such a voltage E2 can be determined through an experiment.

In the charging as above, for example, when the battery voltage is raised by constant-current charging to the preliminary reference voltage E2, if the detected battery temperature is within such a high-temperature region, the charging operation is switched to a constant-voltage charging at the preliminary reference voltage E2, and continued to the termination of charging operation. In short, when the detected battery temperature is within a high-temperature region, a constant-current and constant-voltage charging is performed with the end-of-charge voltage being set at the preliminary reference voltage E2. By charging in this way, even when the battery temperature is within a high-temperature region, the lithium ion secondary battery can be charged with a maximum quantity of electricity within a range that does not accelerate the deterioration of the battery.

On the other hand, when the battery voltage is raised to the preliminary reference voltage E2, if the detected battery temperature is below such a temperature region, the constant-current charging of the lithium ion secondary battery is performed until the battery voltage reaches a higher reference voltage E1, and then switched to a constant-voltage charging. By charging in this way, a constant-current and constant-voltage charging with a higher end-of-charge voltage is made possible. Therefore, charging/discharging that can utilize the real capacity of the lithium ion secondary battery as much as possible is realized.

Here, the preliminary reference voltage E2 can be set within the range of 89.5 to 99% and preferably within the range of 90 to 99% of the voltage of the lithium ion secondary battery in a fully charged state based on the rated capacity.

The charging system for a lithium ion secondary battery according to the present invention includes: a remaining capacity detecting unit for detecting a remaining capacity of the lithium ion secondary battery; a temperature detecting unit for detecting a temperature of the lithium ion secondary battery; a voltage measuring unit for detecting a voltage of the lithium ion secondary battery; and a charge controller for controlling the charging of the lithium ion secondary battery upon reception of input signals from the remaining capacity detecting unit, the temperature detecting unit, and the voltage measuring unit. The charge controller controls the charging of the lithium ion secondary battery by the above-described charging method.

The embodiments of the present invention are described below with reference to the appended drawings.

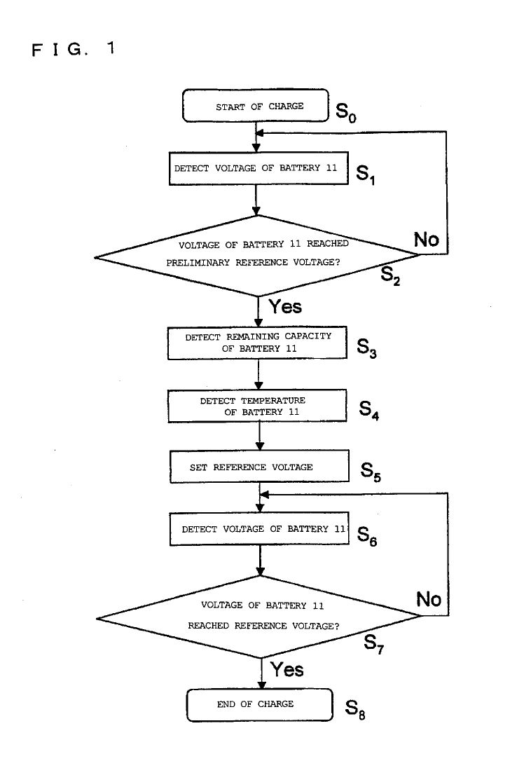

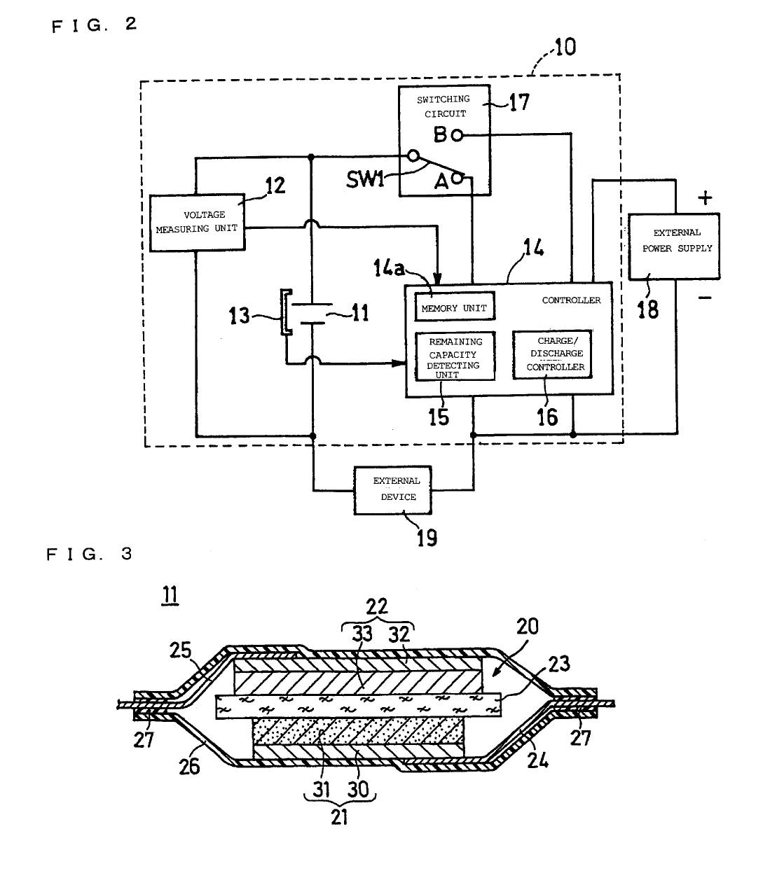

FIG. 1 is a flowchart for explaining each step in a charging method for a lithium ion secondary battery, according to one embodiment of the present invention. FIG. 2 is a functional block diagram schematically showing the configuration of a charging system for a lithium ion secondary battery, to which the charging method is applied.

The charging of a lithium ion secondary battery of this embodiment is performed for a lithium ion secondary battery 11 after having been discharged to supply power to an external device 19 as shown in FIG. 2. The lithium ion secondary battery 11 is preferably an alloy-type secondary battery having a negative electrode including an alloy-formable active material.

A charging system 10 of a lithium ion secondary battery as shown in FIG. 2 includes the lithium ion secondary battery 11 (hereinafter simply referred to as the “battery 11”), a voltage measuring unit 12 for detecting a voltage of the battery 11, a temperature detecting unit 13 provided with a temperature sensor for detecting a temperature of the battery 11, a controller 14, and a switching circuit 17. The charging system 10 is connected to an external power supply 18 and the external device 19. The temperature of the battery 11 detected by the temperature detecting unit 13 may be either a surface temperature of the battery 11 or an ambient temperature around the battery 11.

The controller 14 includes a memory unit 14a, a remaining capacity detecting unit 15 for detecting a remaining capacity of the battery 11, and a charge/discharge controller 16 for controlling charging and discharging of the battery 11, and controls the timing and conditions for charging and discharging. The controller 14 is configured as, for example, a processing circuit including a microcomputer or CPU, an interface, a memory, and a timer. Various memories may be used as the memory unit 14a, and for example, a read only memory (ROM), a random access memory (RAM), a semiconductor memory, or a nonvolatile flash memory may be used. The external device 19 may be electronic equipment, electric equipment, transportation equipment, or machining equipment that uses the battery 11 as its power source.

The switching circuit 17 includes a switch SW1 for switching charging and discharging of the battery 11, a terminal A to be connected to the battery 11, and a terminal B to be connected to the battery 11. When the switch SW1 in the switching circuit 17 is in contact with the terminal A, the battery 11 is connected to the external device 19 via the controller 14. At this time, discharging from the battery 11 to the external device 19 is performed. When the switch SW1 in the switching circuit 17 is in contact with the terminal B, the battery 11 is connected to the external power supply 18 via the controller 14. At this time, charging of the battery 11 by the external power supply 18 is performed. Although a more detailed description is given hereinafter with reference to FIG. 3, the battery 11 includes a negative electrode 22 including a negative electrode active material layer 33 which contains an alloy-formable active material, and lithium is supplemented beforehand into the negative electrode active material layer 33 in an amount equivalent to the irreversible capacity, prior to fabrication of the battery 11.

In the charging method for the lithium ion secondary battery 11 of this embodiment, as shown in FIG. 1, first, the lithium ion secondary battery 11 that has been discharged to supply power to the external device 19 is subjected to a preliminarily charging process (S0). Specifically, the switching circuit 17 is switched from the “discharge (terminal A)” position to the “charge (terminal B)” position, and the battery 11 is connected to the external power supply 18.

While charging is continued, the voltage measuring unit 12 detects a voltage of the battery 11 at predetermined time intervals (S1). In this embodiment, the voltage of the battery 11 is detected at intervals of, for example, 30 seconds to 5 minutes. Various voltmeters may be used as the voltage measuring unit 12.

The voltage value measured by the voltage measuring unit 12 is output continually to the memory unit 14a in the controller 14. The preliminary reference voltage E2 which is set beforehand is stored in the memory unit 14a. The preliminary reference voltage E2 is set, for example, within the range of 90% to 99% of the end-of-charge voltage of the battery 11. Here, the end-of-charge voltage of the battery 11 is set beforehand on the basis of the rated capacity of the battery 11.

It is preferable to charge the battery 11 at a constant current until the voltage of the battery 11 reaches the preliminary reference voltage E2. The current value in the constant-current charging is set on the basis of, for example, the rated capacity of the battery 11. The current value thus set can be stored in the memory unit 14a. Specifically, for example, provided that the rated capacity of the battery 11 is 1000 mAh to 5000 mAh, the current value in the constant-current charging is preferably 0.3 C to 2.0 C. Here, 1 C is a current value at which the quantity of electricity corresponding to the rated capacity can be discharged just in one hour. An extremely low current value is not practical because it prolongs the charging time. On the other hand, an extremely high current value increases the polarization at the positive and negative electrodes too much, which may result in a failure of accurate calculation of the voltage and the remaining capacity.

Next, the remaining capacity detecting unit 15 or the charge/discharge controller 16 performs a calculation for comparing the voltage of the battery 11 detected by the voltage measuring unit 12 in step S1 with the preliminary reference voltage E2 (S2). Specifically, when the voltage of the battery 11 is equal to or exceeds the preliminary reference voltage E2, it is judged as “Yes” by the remaining capacity detecting unit 15. Then, the preliminary charging process is terminated, and the charging operation proceeds to step S3. When the voltage of the battery 11 is below the preliminary reference voltage E2, it is judged as “No” by the remaining capacity detecting unit 15. Then, the charging operation returns to step S1. Steps S1 and S2 are repeated until it is judged as “Yes” in step S2.

Next, the remaining capacity detecting unit 15 performs a remaining capacity detection process (S3). Specifically, the remaining capacity detecting unit 15 or the charge/discharge controller 16 detects a remaining capacity of the battery 11 at the end of the preliminary charging process (S2). The remaining capacity detecting unit 15 determines a remaining capacity AQ of the battery 11 before the start of charging (S0), and adds a quantity of electricity charged in the preliminary charging process thereto, to detect a remaining capacity BQ of the battery 11 at the end of the preliminary charging process (S2).

The remaining capacity AQ of the battery 11 before the start of charging (S0) is determined by summing products obtained by multiplying the discharge current value of the battery 11 discharged from its fully charged state by the discharge time, to calculate a quantity of electricity supplied from the battery 11 to the external device 19, and then subtracting the calculated quantity of electricity from the rated capacity of the battery 11. Specifically, the remaining capacity detecting unit 15 performs a calculation: “Remaining capacity of the battery 11 (mAh)=Rated capacity of battery 11 (mAh)−Discharge current value (CmA)×Time (sec)”, to detect a remaining capacity AQ of battery 11. The detection result thus obtained is input into the memory unit 14a. The rated capacity of the battery 11 and the program of the above calculation are input beforehand into the memory unit 14a.

In the preliminary charging process, a constant-current charging is performed. The current value in this constant-current charging is stored in the memory unit 14a. In addition, a timer (not shown) installed in the controller 14 calculates a time from the start of the preliminary charging process (S0) to the end (corresponding to “Yes” in S2) of the preliminary charging process, and the time is input into the memory unit 14a. From these data, the remaining capacity detecting unit 15 performs a calculation: “Current value in constant-current charging (CmA)×Charge time (sec)”, to determine a quantity of electricity charged into the battery 11 in the preliminary charging process.

The remaining capacity detecting unit 15 performs a calculation: “Remaining capacity AQ+Quantity of electricity charged into battery 11 in preliminarily charging process”, to detect a remaining capacity BQ of the battery 11 at the end of the preliminarily charging process. The detection result thus obtained is input into the memory unit 14a. The rated capacity of the battery 11 and the program of each of the above calculations are input beforehand into the memory unit 14a.

The preliminarily charging process may be omitted, and the remaining capacity and temperature of the battery 11 after discharge may be immediately detected, to set the reference voltage E1 from the detected remaining capacity and temperature. In this case, the above-determined remaining capacity AQ of the battery 11 before the start of charging is used as the remaining capacity of the battery 11.

For more accurate detection of remaining capacities AQ and BQ of the battery 11, the charging/discharging system 10 may further include a current value detecting unit for detecting a current value, and a charge time detecting unit for detecting a charge time. The current values during constant-current discharging and constant-current charging may fluctuate, although the width of fluctuation is small. In the case where the charging/discharging system 11 is provided with a current value detecting unit, the current values during charging can be accurately detected. The current value detecting unit may be an ammeter. The charge time detecting unit may be a timer.

The charge time at each current value is detected by the current value detecting unit and the charge time detecting unit, and input into the memory unit 14a. The remaining capacity detecting unit 15 performs a calculation: “Remaining capacity of battery 11 (mAh)={Rated capacity of battery 11 (mAh)−[Current value 1 (CmA)×Total charge time at current value 1 (sec)+Current value 2 (CmA)×Total charge time at current value 2 (sec)+ . . . Current value X (CmA)×Total charge time at current value X (sec)]}”, to detect the remaining capacity of the battery 11. The detected remaining capacity is input into the memory unit 14a.

Next, a temperature detection process is performed (S4). Specifically, the temperature sensor 13, under the control of the controller 14, detects a temperature of the battery 11 having been subjected to the preliminary charging process. The detection result is input into the memory unit 14a. Although step S4 is performed after step S3 in this embodiment, steps S3 and S4 may be performed simultaneously, or alternatively, step S3 is performed after step S4. After the completion of steps S3 and S4, process goes to step S5.

Next, a voltage calibration process is performed (S5). Specifically, first, the remaining capacity detecting unit 15 sets a reference voltage higher than the preliminary reference voltage, from the detection result in step S3 of the remaining capacity of the battery 11 and the detection result in step S4 of the temperature of the battery 11.

For example, the reference voltage is set as follows. First, while the temperature of the battery 11 is varied, a relationship at each temperature of the battery 11 between the remaining capacity of the battery 11 and the end-of-charge voltage that gives a predetermined utilization rate of the positive electrode is determined beforehand through an experiment, to prepare a first data table. In the first data table of this embodiment, the end-of-charge voltage is set such that the utilization rate of the positive electrode reaches 95% to 99%. The first data table is input beforehand into the memory unit 14a.

The remaining capacity detecting unit 15 determines the reference voltage E1 on the basis of the remaining capacity of the battery 11 (S3), the temperature of the battery 11 (S4), and the first data table. The reference voltage E1 is set on the basis of the end-of-charge voltage read from the first data table, such that the utilization rate of the positive electrode will not exceed 100%. For example, when the temperature of the battery 11 is 40° C. to 60° C., and the remaining capacity of the battery 11 is 80 to 95% of the rated capacity of the battery 11, the reference voltage E1 is set within the range of 90 to 99% of the end-of-charge voltage read from the first data table. When the battery temperature is below 40° C., the reference voltage E1 is set to a higher voltage within the above range. It should be noted that in the case where a preliminary charging process according to the preliminary reference voltage is performed, the preliminary charging process is followed by further charging, and therefore, the reference voltage E1 is usually set higher than the preliminary reference voltage E2. Thereafter, process goes to step S6.

Next, a charging process is performed (S6). In the charging process, the battery 11 is charged at a constant current until the voltage of the battery 11 reaches the reference voltage E1. The current value in this constant-current charging is not particularly limited, but is preferably selected, for example, from the range of 0.3 to 2.0 C when the rated capacity of the battery 11 is 1000 to 5000 mAh. The reference voltage E1 is preferably selected from the range of 3.5 to 4.5 V.

An excessively low current value in the constant-current charging prolongs the charge time, and thus, is not practical. On the other hand, an excessively high current value in the constant-current charging increases the polarization at the positive electrode and the negative electrode too much, which may result in a failure of accurate detection of voltage.

In the charging process, the voltage value of the battery 11 is detected at predetermined time intervals, while charging is continued. Specifically, the controller 14 controls the voltage measuring unit 12, to detect the voltage of the battery 11 at predetermined time intervals. Here, the length of each time interval is not particularly limited, but is preferably 30 seconds to 5 minutes. Thereafter, process goes to step S7.

Next, the remaining capacity detecting unit 15 or the charge/discharge controller 16 performs a calculation for comparing the voltage of the battery 11 detected by the voltage measuring unit 12 in step S6 with the reference voltage E1. When the voltage of the battery 11 is equal to or exceeds the reference voltage E1, it is judged as “Yes”, and the battery 11 is subjected to a constant-voltage charging at the reference voltage E1. In the constant-voltage charging, when the charge current drops to a predetermined end-of-charge current, the charging process is terminated, and the charging operation is completed (S8). When the voltage of the battery 11 is below the reference voltage E1, it is judged as “No”. Then, the charging operation returns to step S6. Steps S6 and S7 are repeated until it is judged as “Yes” in step S7.

Steps S0 to S8 are performed in the manner as described above, whereby the battery 11 is charged. In this process, the battery 11 is charged using, as an end-of-charge voltage, the reference voltage E1 which is set beforehand in association with the temperature of the battery 11, and therefore, the battery 11 can be charged so that the utilization rate of the positive electrode 21 is kept substantially constant, without exceeding 100%. As a result, it is possible to significantly suppress the structural destruction of the positive electrode active material layer 31 and the decomposition of the non-aqueous electrolyte on the surface of the positive electrode active material layer 31, without reducing the capacity of the battery 11. Consequently, the cycle characteristics of the battery 11 can be improved.

Although in the charging system 10 of this embodiment, the remaining capacity of the battery 11 is determined from the relationship between the current value and the discharge time or charge time, this is not a limitation, and the remaining capacity of the battery 11 may be determined from the voltage value of the battery 11. For example, the detection of the remaining capacity of the battery 11 based on the voltage value of the battery 11 is carried out as follows.

First, a second data table showing a relationship between the voltage and the remaining capacity of the battery 11 is prepared and input into the memory unit 14a beforehand. It is preferable to prepare the second data table at varying battery temperatures. The voltage measuring unit 12 detects the voltage of the battery 11, and inputs the detected voltage into the memory unit 14a. The remaining capacity detecting unit 15 retrieves the second data table and the detected voltage value from the memory unit 14a, and checks the second data table against the detected voltage value, to detect a remaining capacity of the battery 11. At this time, it is preferable that the temperature of the battery 11 is detected by the temperature detecting unit 13 to select a second data table according to the detected temperature value, and the second data table thus selected is checked against the detected voltage value, thereby to detect the remaining capacity. This allows more accurate determination of the remaining capacity.

Next, the configuration of the battery 11 is described with reference to FIG. 3. FIG. 3 is a longitudinal cross-sectional view schematically showing the configuration of the battery 11 included in the charging/discharging system 10 shown in FIG. 1. The battery 11 can be prepared by placing a laminated electrode group 20 and a non-aqueous electrolyte (not shown) in a battery case 26 being made of a laminate film and having openings at its both ends, and then welding each of the both openings of the battery case 26 with a gasket 27 interposed therebetween, to seal the case.

The laminated electrode group 20 can be formed by laminating a positive electrode 21 and a negative electrode 22 with a separator 23 interposed therebetween. One end of a positive electrode lead 24 is connected to a positive electrode current collector 30 of the positive electrode 21, and the other end thereof is extended outside through one opening of the battery case 26. One end of a negative electrode lead 25 is connected to a negative electrode current collector 32 of the negative electrode 22, and the other end thereof is extended outside through the other opening of the battery case 26. After these leads have been extended outside, the both openings of the battery case 26 are each sealed with the gasket 27 interposed therebetween. Here, each of the both openings of the battery case 26 may be welded directly without using the gasket 27.

The positive electrode 21 includes the positive electrode current collector 30 and a positive electrode active material layer 31 formed on a surface of the positive electrode current collector 30.

The positive electrode current collector 30 is, for example, a metal foil made of a metal material such as stainless steel, titanium, aluminum, or an aluminum alloy. The thickness of the positive electrode current collector 30 is preferably 5 μm to 50 μm.

The positive electrode active material layer 31 can be formed by, for example, applying a positive electrode material mixture slurry onto a surface of the positive electrode current collector 30, and drying and rolling the resultant film. Although the positive electrode active material layer 31 is formed on one surface of the positive electrode current collector 30 in this embodiment, it may be formed on both surfaces. The positive electrode material mixture slurry can be prepared by mixing a positive electrode active material, a conductive agent, and a binder with a solvent.

The positive electrode active material may be any positive electrode active material used for lithium ion secondary batteries, and is preferably a lithium-containing composite oxide. Examples of the lithium-containing composite oxide include Li_{Z}CoO₂, Li_{Z}NiO₂, Li_{Z}MnO₂, Li_{Z}CoₘNi₁₋ₘO₂, Li_{Z}CoₘM₁₋ₘOₙ, Li_{Z}Mn₁₋ₘMₘOₙ, Li_{Z}Mn₂O₄, Li_{Z}Mn₂₋ₘMnO₄, where M is at least one element selected from the group consisting of Na, Mg, Sc, Y, Mn, Fe, Co, Ni, Cu, Zn, Al, Cr, Pb, Sb, and B, 0<Z≦1.2, 0≦m 0.9, and 2≦n≦2.3. Among these, Li_{Z}CoₙM₁₋ₘOₙ is preferred.

In each of the above formulae representing the lithium-containing composite oxide, the number of moles of lithium is a value upon synthesis of positive electrode active material, and increases and decreases during charging and discharging. In addition to the lithium-containing composite oxide, an olivine-type lithium phosphate is also preferred. These positive electrode active materials may be used singly or in combination of two or more.

Examples of the conductive agent include: carbon blacks, such as acetylene black and Ketjen black; and graphites, such as natural graphite and artificial graphite. Examples of the binder include: resin materials, such as polytetrafluoroethylene and polyvinylidene fluorides; and rubber materials, such as a styrene-butadiene rubber containing acrylic acid monomers and a styrene-butadiene rubber. Examples of the dispersion medium to be mixed with the positive electrode active material, conductive agent, and binder include: organic solvents, such as N-methyl-2-pyrrolidone, tetrahydrofuran, and dimethylformamide; and water.

The positive electrode material mixture slurry may further include a thickener, such as carboxymethyl cellulose, polyethylene oxide, or a modified polyacrylonitrile rubber.

The negative electrode 22 includes the negative electrode current collector 32 and a negative electrode active material layer 33 formed on a surface of the negative electrode current collector 32. As mentioned above, lithium is supplemented beforehand into the negative electrode in an amount equivalent to the irreversible capacity, prior to fabrication of the battery 11. The irreversible capacity can be determined by, for example, fabricating the battery 11 using the negative electrode 22 without lithium supplemented thereinto, and measuring an increased weight of the negative electrode 22 after subjected to an initial charging.

Lithium can be supplemented by, for example, vacuum vapor deposition or pasting. According to vacuum vapor deposition, lithium is vapor-deposited onto the negative electrode active material layer 33 using a vacuum vapor deposition apparatus, whereby lithium is supplemented. According to pasting, a lithium foil is pasted onto a surface of the negative electrode active material layer 33, to form the battery 11, and the battery 11 is then subjected to an initial charging, whereby lithium is supplemented.

The negative electrode current collector 32 is, for example, a metal foil made of a metal material such as stainless steel, nickel, copper, or a copper alloy. The thickness of the positive electrode current collector is preferably 5 μm to 50 μm.

The negative electrode active material layer 33 can be formed by, for example, applying a negative electrode material mixture slurry onto a surface of the negative electrode current collector 32, and drying and rolling the resultant film. Although the negative electrode active material layer 33 is formed on one surface of the negative electrode current collector 32 in this embodiment, it may be formed on both surfaces. The negative electrode material mixture slurry can be prepared by mixing an alloy-formable active material and a binder with a dispersion medium.

The alloy-formable active material may be any alloy-formable active material used for lithium ion secondary batteries, and is preferably a silicon-based active material and a tin-based active material, and more preferably a silicon-based active material. These alloy-formable active materials may be used singly or in combination of two or more.

The silicon-based active material is not particularly limited, and is preferably silicon or a silicon compound. Examples of the silicon compound include silicon oxides represented by SiOₐ, where 0.05<a<1.95, silicon carbides represented by SiC_{b}, where 0<b<1, silicon nitrides represented by SiN_{c}, where 0<c<4/3, and alloys of silicon and different element R. Examples of difference element R include Fe, Co, Sb, Bi, Pb, Ni, Cu, Zn, Ge, In, Sn, and Ti. Among these, silicon oxides are further preferred.

Examples of the tin-based active material include: tin; tin oxides represented by SnO_{d}, where 0<d<2; tin dioxide; tin nitrides; tin-containing alloys, such as Ni—Sn alloy, Mg—Sn alloy, Fe—Sn alloy, Cu—Sn alloy, and Ti—Sn alloy; and tin compounds, such as SnSiO₃, NiSn₄, and Mg₂Sn. Preferred examples among these include tin oxides, tin-containing alloys, and tin compounds.

Examples of the binder are the same as those used for the positive electrode material mixture slurry.

The negative electrode material mixture slurry may further include a conductive agent and a thickener. Examples of the conductive agent and the thickener are the same as those used for the positive electrode material mixture slurry.

The negative electrode active material layer 33 can be alternatively formed by a vapor phase method. The negative electrode active material layer 33 formed by a vapor phase method is preferably an amorphous or low crystalline thin film made of an alloy-formable active material. Examples of the vapor phase method include vacuum vapor deposition, sputtering, ion plating, laser ablation, chemical vapor deposition, plasma chemical vapor deposition, and flame spraying. Among these, vacuum vapor deposition is preferred.

The negative electrode active material layer 33 is more preferably a thin film composed of a plurality of columnar bodies comprising an alloy-formable active material. The negative electrode active material layer 33 being such a thin film can also be formed by a vapor phase method. In this case, it is preferable to form a plurality of protrusions on a surface of the negative electrode current collector 32 by press-molding, and form one columnar body on one protrusion.

The columnar bodies are formed outwardly from the surfaces of the protrusions on the negative electrode current collector 32. Gaps are present between the columnar bodies adjacent to each other. This reduces the stress generated in association with expansion and contraction of the alloy-formable active material, and thus suppresses the separation of the columnar body from the surface of the protrusion, and the deformation of the negative electrode current collector 32. The height and width of the columnar body are preferably within the ranges from 3 μm to 30 μm and from 5 μm to 30 μm, respectively.

The protrusions may be arranged regularly or irregularly on a surface of the negative electrode current collector 32. Examples of the regular arrangement include a staggered arrangement, a closest-packed arrangement, and a lattice arrangement. The height and width of the protrusion are preferably within the ranges from 10 μm to 20 μm and from 5 μm to 30 μm, respectively. The top of the protrusion is preferably a flat surface substantially parallel with the surface of the negative electrode current collector 32. The shape of the protrusion in an orthographic projection of the negative electrode current collector 32 viewed from vertically above is, for example, rhomboid, square, rectangular, circular, or elliptic.

The separator 23 may be, for example, a porous sheet having pores, a nonwoven fabric of resin fibers, or a woven fabric of resin fibers. Among these, a porous sheet is preferred, and a porous sheet having a pore diameter of about 0.05 μm to 0.15 μm is more preferred. Examples of the resin materials constituting the porous sheet and the resin fibers include: polyolefins, such as polyethylene and polypropylene; polyamide; and polyamide-imide. The thickness of the separator 23 is preferably 5 μm to 30 μm.

The non-aqueous electrolyte contains a lithium salt and a non-aqueous solvent. Examples of the lithium salt include LiPF₆, LiClO₄, LiBF₄, LiAlCl₄, LiSbF₆, LiSCN, LiAsF₆, LiB₁₀Cl₁₀, LiCl, LiBr, LiI, LiCO₂CF₃, LiSO₃CF₃, Li (SO₃CF₃)₂, LiN(SO₂CF₃)₂, and lithium imide salts. These lithium salts may be used singly or in combination of two or more. The concentration of the lithium salt in 1 L of the non-aqueous solvent is preferably 0.2 mol to 2 mol, and more preferably 0.5 mol to 1.5 mol.

Examples of the non-aqueous solvent include: cyclic carbonic acid esters, such as ethylene carbonate, propylene carbonate, and butylene carbonate; chain carbonic acid esters, such as dimethyl carbonate, ethyl methyl carbonate, and diethyl carbonate; chain ethers, such as 1,2-dimethoxy ethane and 1,2-diethoxy ethane; cyclic carboxylic acid esters, such as γ-butyrolactone and γ-valerolactone; and chain esters, such as methyl acetate. These non-aqueous solvents may be used singly or in combination of two or more.

Description is made in this embodiment on the battery 11 including the battery case 26 made of a laminate film accommodating the laminated electrode group 20, but this is not a limitation, and it is possible to use as the battery 11, for example, a battery including a cylindrical or prismatic battery case accommodating a wound electrode group, a battery including a prismatic battery case accommodating a wound electrode group which is further molded into a flat shape, or a battery including a coin-type battery case accommodating a laminated electrode group.

Next, the present invention is more specifically described with reference to Examples and Comparative Examples.

### Example 1

### (a) Production of Positive Electrode Plate

A lithium-containing nickel composite oxide containing cobalt and aluminum, LiNi_{0.85}Co_{0.15}Al_{0.05}O₂, was used as the positive electrode active material.

First, 85 parts by mass of the positive electrode active material, 10 parts by mass of carbon powder, and an N-methyl-2-pyrrolidone solution containing 5 parts by mass of polyvinylidene fluoride were mixed, to prepare a positive electrode material mixture slurry. Subsequently, the positive electrode material mixture slurry was applied onto one surface of a 15-μm-thick aluminum foil (a positive electrode current collector), and the resultant film was dried and rolled, to form a positive electrode having a thickness of 70 μm. The resultant positive electrode was cut into a positive electrode plate including an active material formed portion of 20 mm square in size and a lead connecting portion of 5 mm square in size.

### (b) Production of Negative Electrode Plate

(b-1) Preparation of Negative Electrode Current Collector

A forged steel roller having a surface with a plurality of recesses arranged thereon in a staggered pattern and a stainless steel roller having a smooth surface were press-fitted to each other with the axes thereof being arranged in parallel with each other, to form a press-fit nip portion. A belt-like 35-μm-thick electrolytic copper foil (available from Furukawa Circuit Foil Co., Ltd.) was passed through the press-fit nip portion at a line pressure of 1 t/cm, whereby a negative electrode current collector having a plurality of protrusions on one surface thereof was prepared.

The protrusions had an average height of 8 μm, and were arranged in a staggered pattern. The top end of the protrusion was a flat surface substantially parallel with the surface of the negative electrode current collector. The shape of the protrusion in an orthographic projection viewed from vertically above was approximately circular. The distance between the protrusions was 20 μm in the longitudinal direction of the negative electrode current collector, and 15 μm in the lateral direction thereof.

(b-2) Formation of Negative Electrode Active Material Layer

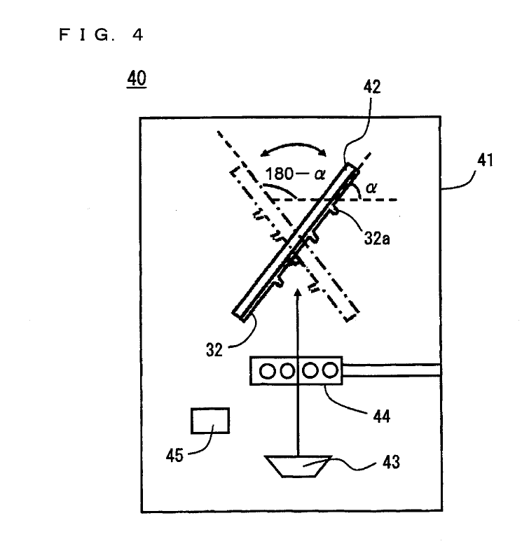

FIG. 4 is a side view schematically showing the internal configuration of an electron beam vacuum vapor deposition apparatus 40 (available from ULVAC, Inc., hereinafter referred to as a “vapor deposition apparatus 40”). In FIG. 4, the negative electrode current collector obtained in the above is shown as the negative electrode current collector 32. Specifically, the negative electrode current collector 32 has a plurality of protrusions 32a on one surface thereof.

The vapor deposition apparatus 40 includes a chamber 41 being a pressure-resistant container, in which a fixing table 42 for fixing the negative electrode current collector 32 thereon, a target 43 for accommodating a raw material of alloy-formable active material, a nozzle 44 for supplying a raw material gas such as oxygen or nitrogen, an electron beam generator 45 for irradiating the target 43 with electron beams are disposed. The target 43 is arranged vertically below the fixing table 42, and the nozzle 44 is arranged vertically between the fixing table 42 and the target 43.

The fixing table 42 is arranged such that it swings between the position indicated by the solid line in FIG. 4 (i.e., the position at which the fixing table 42 and the horizontal line intersect at an angle α) and the position indicated by the dash-dot line (i.e., the position at which the fixing table 42 and the horizontal line intersect at an angle 180-α). In this example, α=60°.

First, the fixing table 42 was set at the position indicated by the solid line in FIG. 4, to form a first active material layer on the surface of each protrusion 32a, and then, the fixing table 42 was set at the position indicated by the dash-dot line, to form a second active material layer mainly on the surface of each first active material layer, the second active material layer growing in a different direction from the first active material layer. In this way, the position of the fixing table 42 was alternated between the positions indicated by the solid line and the dash-dot line in FIG. 4 such that it was positioned 25 times at each position, to alternately stack the first active material layer and the second active material layer. In such a manner, one columnar body was formed on one protrusion 32a, and a negative electrode active material layer including a plurality of columnar bodies was formed. A negative electrode was thus produced.

The columnar bodies have been grown outwardly from the top and the side surface near the top of each protrusion 32a on the negative electrode current collector 32. The average height of the columnar bodies was 20 μm. The content of oxygen in the columnar bodies was determined by a combustion method, and the result found that the composition of the columnar bodies was SiO_{0.2}.

The conditions for vapor deposition were as follows.

Raw material of negative electrode active material (target 43): silicon, purity 99.9999%, available from Kojundo Chemical Lab. Co., Ltd.

Oxygen ejected from nozzle 44: purity 99.7%, available from Nippon Sanso Corporation

Flow rate of oxygen ejected from nozzle 44: 80 sccm

Accelerating voltage of electron beams: −8 kV

Emission: 500 mA

Duration of one vapor deposition at each of positions indicated by solid line and dash-dot line in FIG. 4: 3 min

The negative electrode obtained in the above was fixed at a predetermined position in a resistance heating vapor deposition apparatus (available from ULVAC, Inc.), and lithium metal was placed on a tantalum boat. The atmosphere in the vapor deposition apparatus was replaced with an argon atmosphere, and then a current of 50 A was passed through the tantalum boat, to vapor-deposit lithium onto the negative electrode for 10 minutes. In this way, lithium was supplemented into the negative electrode in an amount equivalent to the irreversible capacity. The negative electrode with lithium supplemented thereinto was cut into a negative electrode plate including an active material formed portion of 21 mm square in size and a lead connecting portion of 5 mm square in size.

### (c) Preparation of Non-Aqueous Electrolyte

LiPF₆ was dissolved at a concentration of 1.2 mol/L in a mixed solvent containing ethylene carbonate, ethyl methyl carbonate, and diethyl carbonate in the ratio of 2:3:5 by volume. To 100 parts by mass of the resultant solution, 5 parts by mass of vinylene carbonate was added and mixed, to prepare a non-aqueous electrolyte.

### (d) Fabrication of Battery

The positive and negative electrode plates were laminated with a polyethylene porous film (thickness: 20 μm, trade name: Hipore, available from Asahi Kasei Corporation) interposed therebetween, to form a laminated electrode group. One end of an aluminum lead was connected to the positive electrode current collector, and one end of a nickel lead was connected to the negative electrode current collector. Next, the laminated electrode group and the non-aqueous electrolyte were placed in a battery case made of an aluminum laminate film, and the other ends of the aluminum lead and the nickel lead were extended outside the battery case thorough the openings, respectively. While the pressure in the battery case was reduced to near vacuum, each of the openings of the battery case was welded with a polypropylene gasket interposed therebetween. A lithium ion secondary battery (rated capacity: 400 mAh) was thus fabricated.

The battery thus fabricated was subjected to 300 charge/discharge cycles in a 25° C. environment, each cycle consisting of a charging under the below-described conditions, and a subsequent constant-current discharging (1.0 C, end-of-discharge voltage: 2.5 V, interval: 40 min), to determine a ratio of a discharge capacity at the 300^{th} charge/discharge cycle to a discharge capacity at the 1^{st} charge/discharge cycle as a percentage, which was defined as a capacity retention rate (%). The discharge capacity after the 1^{st} charge/discharge cycle was defined as a battery capacity. The results are shown in Table 1.

A thickness X of the battery before subjected to charge/discharge and a thickness Y of the battery after subjected to 300 charge/discharge cycles were measured, and a battery swelling ratio was calculated from the equation below. A higher battery swelling ratio means a higher degree of swelling of the battery. The results are shown in Table 1.

Battery swelling ratio=(Y−X)/X.

### [Conditions for Charging]

### (1) Preliminarily Charging Process

First, with regard to the preliminary reference voltage E2, an end-of-charge voltage of the battery was determined through an experiment on the assumption that the operating temperature of the battery in normal use was within the range of −10 to 60° C., such that the utilization rate of the positive electrode active material would not exceed 100%, at the upper limit temperature, 60° C. The end-of-charge voltage thus determined was 4.15 V. Based on this, the preliminary reference voltage was set to 4 V. This preliminary reference voltage was about 96% of the end-of-charge voltage.

### (2) Remaining Capacity Detection Process

Next, in the remaining capacity detection process at the n^{th} cycle (n>2), the remaining capacity was determined with reference to the discharge time at the (n−1)^{th} cycle, by calculating (1.0 C×400×discharge time at the (n−1)^{th} cycle (min)÷60), where 400 is the rated capacity (mAh) of the battery. In the case where n=1, the remaining capacity was determined with reference to the rated capacity.

In the preliminary charging process, the battery was charged at a current value of 0.7 C for 75 minutes until the battery voltage reached the preliminary reference voltage E2 (4 V). The capacity charged into the battery was: 0.7 (C)×400 (mAh)×75 (min) 60÷350 (mAh). The remaining capacity BQ of the battery after the preliminary charging process is calculated as follows: “remaining capacity AQ+capacity charged into battery in preliminary charging process”. The calculated value was 350 mAh. This was about 87.6% of the rated capacity of an above-fabricated battery.

### (3) Temperature Detection Process

The battery temperature was 45° C. in this Example.

### (4) Voltage Calibration Process

The reference voltage E1 for the fabricated battery (i.e., the end-of-charge voltage in this process) determined on the basis of the remaining capacity 350 mAh and the battery temperature 45° C., with the utilization rate of the positive electrode set at 95% was 4.075 V.

### (5) Charging Process

The battery was charged by constant-current charging at a current value of 0.7 C until the battery voltage reached the reference voltage E1.

### Comparative Example 1

The battery was subjected to 300 charge/discharge cycles in the same manner as in Example 1, except that the charging was changed to a constant-current charging and a subsequent constant-voltage charging which were performed in a 25° C. environment under the below-described conditions, to determine the capacity retention rate (%) and the battery swelling ratio. The results are shown in Table 1.

### [Conditions for Charging]

Constant-current charging: 0.7 C, end-of-charge voltage 4.15 V

Constant-voltage charging: 4.15 V, end-of-charge current 0.05 C, interval 20 min

TABLE 1

| | Discharge | Capacity | Battery swelling |
|---|---|---|---|
| | capacity | retention rate | ratio |
| | (mAh) | (%) | (%) |
| Ex. 1 | 244 | 61 | 12 |
| Com. Ex. 1 | 180 | 45 | 22 |

Table 1 shows that according to the charging method of the present invention, the deterioration in the characteristics of the battery is significantly suppressed, and the swelling of the battery becomes very small. This is presumably because, according to the charging method of the present invention, the amount of lithium to be absorbed in the positive electrode during discharging is adjusted such that it will not exceed the theoretical amount, and therefore, the structural destruction of the positive electrode active material layer, the decomposition of the non-aqueous electrolyte on the surface of the positive electrode current collector, and the like are suppress.

### INDUSTRIAL APPLICABILITY

The charging method of the present invention is applicable to the conventional charging system provided with a lithium ion secondary battery, and is particularly useful for a main power source or an auxiliary power source for, for example, electronic equipment, electric equipment, machining equipment, transportation equipment, and power storage equipment. Examples of the electronic equipment include personal computers, cellular phones, mobile devices, personal digital assistants, and portable game machines. Examples of the electric equipment include vacuum cleaners and video cameras. Examples of the machining equipment include electric powered tools and robots. Examples of the transportation equipment include electric vehicles, hybrid electric vehicles, plug-in HEVs, and fuel cell-powered vehicles. Examples of the power storage equipment include uninterrupted power supplies.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Charging system
11 Lithium ion secondary battery
12 Voltage measuring unit
13 Temperature detecting unit
14 Controller
14a Memory unit
15 Remaining capacity detecting unit
16 Charge/discharge controller
17 Switching circuit
18 External power supply
19 External device

1. A charging method for a lithium ion secondary battery which comprises a positive electrode including a positive electrode active material capable of absorbing and releasing lithium ions, a negative electrode including a negative electrode active material being an alloy-formable active material capable of absorbing and releasing lithium ions, a separator interposed between the positive electrode and the negative electrode, and a non-aqueous electrolyte,
the method comprising the steps of:
detecting a remaining capacity and a temperature of the lithium ion secondary battery; and
charging the lithium ion secondary battery until a battery voltage reaches a reference voltage E1 associated beforehand with the remaining capacity and the temperature.

2. The charging method for a lithium ion secondary battery in accordance with claim 1, wherein the remaining capacity is detected by integrating products of a discharge current value of the lithium ion secondary battery and a discharge time thereof.

3. The charging method for a lithium ion secondary battery in accordance with claim 1, wherein the remaining capacity is detected by measuring a voltage of the lithium ion secondary battery.

4. The charging method for a lithium ion secondary battery in accordance with claim 1, wherein the reference voltage E1 is set within a range of 90 to 99.5% of a voltage of the lithium ion secondary battery in a fully charged state, when the temperature detected is within a range of 40 to 60° C.

5. The charging method for a lithium ion secondary battery in accordance with claim 1, further comprising the step of preliminarily charging the lithium ion secondary battery before the detecting step, by constant-current charging until the battery voltage reaches a preliminary reference voltage E2 satisfying E1≧E2.

6. The charging method for a lithium ion secondary battery in accordance with claim 5, wherein the preliminary reference voltage E2 is set within a range of 89.5 to 99% of the voltage of the lithium ion secondary battery in a fully charged state.

7. A charging system for a lithium ion secondary battery, the system comprising:
a remaining capacity detecting unit for detecting a remaining capacity of the lithium ion secondary battery;
a temperature detecting unit for detecting a temperature of the lithium ion secondary battery;
a voltage measuring unit for detecting a voltage of the lithium ion secondary battery; and
a charge controller for controlling charging of the lithium ion secondary battery upon reception of input signals from the remaining capacity detecting unit, the temperature detecting unit, and the voltage measuring unit, wherein
the charge controller charges the lithium ion secondary battery by the charging method of claim 1.
